(19) United States
(12) Patent Application Publication
(10) Pub. No.: US 2026/0236806 A1
(43) Pub. Date: Aug. 13, 2026

(54) AGENT INTERACTION METHOD, APPARATUS, MEDIUM, DEVICE, AND COMPUTER PROGRAM PRODUCT

(71) Applicant: Beijing Volcano Engine Technology Co., Ltd., Beijing (CN)

(72) Inventors: Pengfei JIANG, Beijing (CN); Jiyuan TANG, Beijing (CN); Lei HONG, Beijing (CN)

(21) Appl. No.: 19/538,814

(22) Filed: Feb. 12, 2026

(30) Foreign Application Priority Data
Feb. 13, 2025 (CN) 202510162166.1

(51) Int. Cl. G06N 5/043; G06N 5/02

(52) U.S. Cl. CPC G06N 5/043; G06N 5/02

(57) ABSTRACT

The present disclosure provides an agent interaction method and apparatus, a medium, a device, and a computer program product. The method includes: acquiring interaction information corresponding to an interaction operation; determining an interaction agent from a target agent, where the target agent includes multiple sub-agents with an association relationship, different sub-agents correspond to different prompts, and the interaction agent is one of the multiple sub-agents; determining an inference result of the interaction information based on a prompt corresponding to the interaction agent and a model corresponding to the interaction agent; and determining response information of the interaction information based on the inference result, and outputting the response information.

### CROSS-REFERENCE TO RELATED APPLICATION(S)

This application claims priority to Chinese Application No. 202510162166.1 filed on Feb. 13, 2025, the disclosure of which is incorporated herein by reference in its entity.

### FIELD

The present disclosure relates to the field of computer technologies, and specifically, to an agent interaction method, an apparatus, a medium, a device, and a computer program product.

### BACKGROUND

An Agent is generally used to represent an agent that autonomously perceives an environment and takes actions to achieve a goal, and may be implemented based on a large language model (LLM) to have a planning and thinking capability, a memory capability, and a capability of using tool functions.

In the related art, when processing tasks in multiple scenarios, to ensure that the tasks in the multiple scenarios are processed, an Agent is usually provided with a large number of prompts and multiple tools.

### SUMMARY

The part of the summary is provided so as to introduce concepts in a brief form, and these concepts will be described in detail in the following part of detailed description. The part of the summary is not intended to identify key features or necessary features of the claimed technical solution, nor is intended to limit the scope of the claimed technical solution.

In a first aspect, the present disclosure provides an agent interaction method, including:
acquiring interaction information corresponding to an interaction operation;
determining an interaction agent from a target agent, where the target agent includes a plurality of sub-agents with an association relationship, different sub-agents correspond to different prompts, and the interaction agent is one of the plurality of sub-agents;
determining an inference result of the interaction information based on a prompt corresponding to the interaction agent and a model corresponding to the interaction agent; and
determining response information of the interaction information based on the inference result, and outputting the response information.

In a second aspect, the present disclosure provides an agent interaction apparatus, including:
an acquisition module, configured to acquire interaction information corresponding to an interaction operation;
a first determination module, configured to determine an interaction agent from a target agent, where the target agent includes a plurality of sub-agents with an association relationship, different sub-agents correspond to different prompts, and the interaction agent is one of the plurality of sub-agents;
a second determination module, configured to determine an inference result of the interaction information based on a prompt corresponding to the interaction agent and a model corresponding to the interaction agent; and
a processing module, configured to determine response information of the interaction information based on the inference result, and output the response information.

In a third aspect, the present disclosure provides a computer-readable medium, having a computer program stored thereon, where the computer program, when executed by a processing apparatus, implements the steps of the method according to the first aspect.

In a fourth aspect, the present disclosure provides an electronic device, including:
a storage apparatus, having a computer program stored thereon; and
a processing apparatus, configured to execute the computer program in the storage apparatus to implement the steps of the method according to the first aspect.

In a fifth aspect, the present disclosure provides a computer program product, including a computer program, where the computer program, when executed by a processor, implements the steps of the method according to the first aspect.

Other features and advantages of the present disclosure will be described in detail in the following part of detailed description.

### BRIEF DESCRIPTION OF THE DRAWINGS

The above and other features, advantages, and aspects of the embodiments of the present disclosure will become more apparent in combination with the drawings and with reference to the following specific implementations. Throughout the drawings, the same or similar reference numerals represent the same or similar elements. It should be understood that the drawings are schematic, and parts and elements are not necessarily drawn to scale. In the drawings:

FIG. 1 is a flowchart of an agent interaction method according to an implementation of the present disclosure;

FIG. 2 is a schematic diagram of a directed graph provided based on an implementation of the present disclosure;

FIG. 3 is a block diagram of an agent interaction apparatus according to an implementation of the present disclosure; and

FIG. 4 shows a schematic structural diagram of an electronic device suitable for implementing the embodiments of the present disclosure.

### DETAILED DESCRIPTION OF EMBODIMENTS

The embodiments of the present disclosure will be described in more detail below with reference to the drawings. Although some embodiments of the present disclosure are shown in the drawings, it should be understood that the present disclosure may be implemented in various forms, and should not be interpreted as being limited to the embodiments set forth herein. Instead, these embodiments are provided for a more thorough and complete understanding of the present disclosure. It should be understood that the drawings and embodiments of the present disclosure are only for exemplary purposes, and are not intended to limit the protection scope of the present disclosure.

It should be understood that the various steps described in the method implementations of the present disclosure may be executed in different orders and/or in parallel. In addition, the method implementations may include additional steps and/or omit the execution of the steps shown. The scope of the present disclosure will not be limited in this regard.

The term “include/comprise” and its variants used herein are open-ended inclusions, that is, “include/comprise but not limited to”. The term “based on” is “at least partially based on”. The term “an embodiment” represents “at least one embodiment”; the term “another embodiment” represents “at least one other embodiment”; the term “some embodiments” represents “at least some embodiments”. Relevant definitions of other terms will be given in the following description.

It should be noted that the concepts such as “first” and “second” mentioned in the present disclosure are only used to distinguish different apparatuses, modules, or units, and are not used to limit the order of functions performed by these apparatuses, modules, or units, or interdependence therebetween.

It should be noted that the modifiers of “one” and “multiple” mentioned in the present disclosure are illustrative rather than restrictive, and those skilled in the art should understand that they should be understood as “one or multiple” unless otherwise clearly indicated in the context.

The names of messages or information exchanged between multiple apparatuses in the implementations of the present disclosure are only used for illustrative purposes, and are not used to limit the scope of these messages or information.

It may be understood that before the use of the technical solutions disclosed in the embodiments of the present disclosure, the user should be informed of the type, range of use, use scenarios, etc., of personal information involved in the present disclosure in an appropriate manner and the authorization of the user should be obtained in accordance with relevant laws and regulations.

For example, in response to reception of an active request from a user, prompt information is sent to the user to clearly prompt the user that the requested operation will require access to and use of personal information of the user. In this way, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to the reception of the active request from the user, the prompt information may be sent to the user in the form of, for example, a pop-up window, in which the prompt information may be presented in text. In addition, the pop-up window may also include a selection control for the user to choose whether to “agree” or “disagree” to provide the personal information to the electronic device.

It may be understood that the above process of notifying and acquiring user authorization is only illustrative, and does not constitute a limitation on the implementations of the present disclosure. Other manners that satisfy the relevant laws and regulations may also be applied in the implementations of the present disclosure.

At the same time, it may be understood that the data involved in the technical solution (including but not limited to the data itself, acquisition or use of the data) should comply with the requirements of corresponding laws, regulations, and related provisions.

In a process of adjusting and testing the prompts and the tools, the performance of the Agent is likely to deteriorate, and it is difficult to test the Agent.

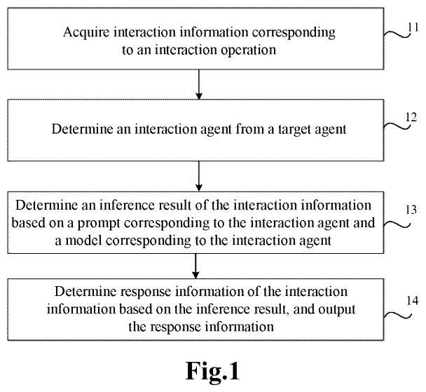

FIG. 1 shows a flowchart of an agent interaction method according to an implementation of the present disclosure. As shown in FIG. 1, the method may include the following steps.

In step 11, interaction information corresponding to an interaction operation is acquired.

Among them, the interaction operation may be a text input operation or a voice input operation of a user in an interaction interface. When the interaction operation is a text input, an input text may be used as the interaction information. When the interaction operation is a voice input, a text obtained after voice recognition of an input voice may be used as the interaction information.

As an example, the interaction operation in the present disclosure is an interaction in a conversation process between a user and an agent, for example, a question-answer pair in the interaction between the user and the agent is used as a round of conversation, one chat between the user and the agent may include one or more rounds of conversations, and each round of conversation belongs to a chat process.

In step 12, an interaction agent is determined from a target agent, where the target agent includes multiple sub-agents with an association relationship, different sub-agents correspond to different prompts, and the interaction agent is one of the multiple sub-agents.

Among them, the target agent may be an agent implemented based on one or more LLMs, where the multiple sub-agents correspond to different prompts, so that different sub-agents may implement different functions. Different sub-agents may correspond to the same model or different models. The multiple sub-agents may be agents that are split from the same agent and have multiple groups of prompts and some tools, and each sub-agent is responsible for one type of task. In this step, the different sub-agents have an association relationship, which may provide data support for the selection of the interaction agent.

In step 13, an inference result of the interaction information is determined based on a prompt corresponding to the interaction agent and a model corresponding to the interaction agent.

As an example, a prompt text “prompt” may be constructed based on the interaction information and the prompt corresponding to the interaction agent, for example, the interaction information may be concatenated to a preset position in the prompt to obtain the prompt text, and then the prompt text may be input to the model corresponding to the interaction agent, so that the model may perform data analysis and inference based on the prompt text to obtain an output result, that is, the inference result of the interaction information. Among them, the model corresponding to the interaction agent may be a model implemented based on an LLM.

In step 14, response information of the interaction information is determined based on the inference result, and the response information is output.

As an example, it may be determined, based on the inference result, whether the inference result may be used as an answer to the interaction information, and if yes, the inference result is used as the response information. As an example, outputting the response information may include displaying, in the interaction interface, a text corresponding to the response information, for example, displaying the text corresponding to the response information in the form of a dialog box. As another example, outputting the response information may include performing speech synthesis based on the text corresponding to the response information to obtain a voice corresponding to the response information, and then outputting the voice in the interaction interface. Among them, the manner of outputting the response information may be determined based on the manner of the interaction operation of the user, that is, when the user interacts through text, the response information is output in text; and when the user interacts through voice, the response information is output in voice.

In the above technical solution, when a user interacts with the target agent, the corresponding interaction agent may be determined from the multiple sub-agents with the association relationship in the target agent, so that the inference result of the interaction information may be determined based on the prompt corresponding to the interaction agent and the model corresponding to the interaction agent, and then the response information of the interaction information of the interaction operation may be determined. Therefore, with the above technical solution, the target agent includes the multiple sub-agents with the association relationship, and different sub-agents correspond to different prompts, so that the interaction of a single agent including a very long prompt and many tools may be transformed into the interaction with the multiple sub-agents with different prompts, which may facilitate the writing and application of the prompt corresponding to the agent, reduce the complexity of the prompt, and improve the efficiency and accuracy of the inference performed by the agent, thereby improving the efficiency and accuracy of the response to the interaction information. In addition, based on the above technical solution, when the prompt or the tool of the agent is adjusted, the single sub-agent may be adjusted, so that the influence of the adjustment of the prompt on the entire target agent may be avoided, and the complexity and influence range of the adjustment of the agent may be effectively reduced, thereby ensuring the accuracy and efficiency of the debugging of the agent, and providing effective support for ensuring the accurate response information.

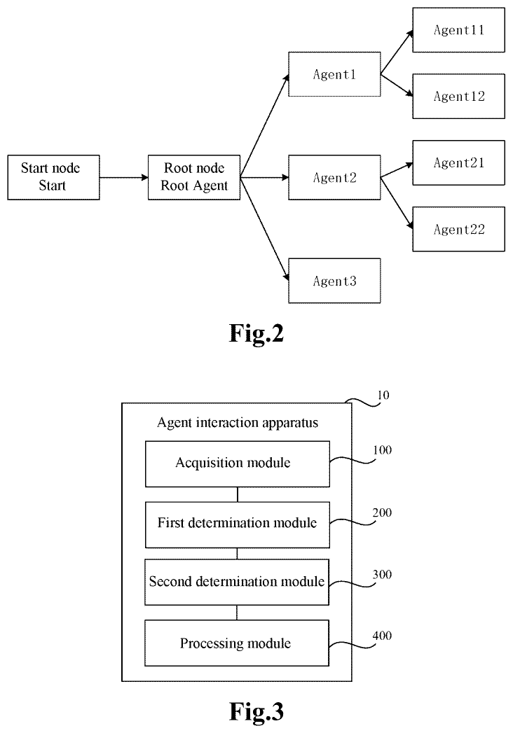

In some embodiments, the association relationship between the multiple sub-agents is represented by a directed graph, and each of the sub-agents corresponds to a node in the directed graph. FIG. 2 is a schematic diagram of a directed graph provided based on an implementation of the present disclosure. Among them, a start node Start is a default start node when the agent processes a new conversation, a root node Root Agent is a successor node of the start node, and the multiple sub-agents include only one root node. A sub-agent node Agent is used to represent the multiple sub-agents included in the target agent, which may include an existing agent or a new agent created by the user. For example, when creating multiple agents (that is, the target agent), the user may register the multiple sub-agents with the target agent in advance, use each of the agents as a sub-agent, and plan the association relationship between different sub-agents. Among them, the directed graph may be pre-configured based on an actual application scenario.

Correspondingly, the determining an interaction agent from a target agent may include:
determining a current node in the directed graph.

Among them, the directed graph indicates a process in which the target agent responds to the interaction information, and the current node may be used to represent a node that needs to be executed currently and that is determined based on the directed graph.

As an example, the determining a current node in the directed graph may include:
acquiring configuration information of the target agent.

Among them, the configuration information may be configured by the user based on an actual application scenario when the user creates the target agent. For example, in some scenarios, each round of conversation needs to be executed from the start node, and in some scenarios, each round of conversation does not need to be executed from the start node. The initial node of each round of conversation may be configured through the configuration information.

As an example, the configuration interface of the target agent may include a configuration box of whether to execute from the start node. If yes is selected, the generated configuration information indicates that the initial node of the interaction operation is the start node. If no is selected or nothing is selected, the configuration information does not indicate that the initial node of the interaction operation is the start node. Correspondingly, the initial node of each round of conversation may be determined based on the configuration information.

If the configuration information indicates that the initial node of the interaction operation is the start node, the start node in the directed graph is used as the current node. In this scenario, the reception of the interaction operation from the user is executed from the start node of the directed graph.

If the configuration information does not indicate that the initial node of the interaction operation is the start node, a node corresponding to a sub-agent of a previous round of interaction operations is used as the current node. This scenario represents that each round of conversation does not need to be executed from the start node. In this case, the execution may be continued based on the historical interaction, and the node corresponding to the sub-agent of the previous round of interaction operations may be used as the current node. As an example, as shown in FIG. 2, if the sub-agent of the previous round of interaction operations is Agent1, the current node is Agent1 after the interaction information is acquired in the current round of interaction. If multiple sub-agents are executed in the previous round of interaction operations, the last sub-agent is used as the sub-agent of the previous round of interaction operations, thereby determining the current node.

Therefore, with the above technical solution, the current node of each round of conversation interaction of the user in the chat of the target agent may be determined based on the configuration information of the target agent, which may provide effective data support for the subsequent selection of the sub-agent based on the directed graph.

After the current node is determined, if the current node is the start node in the directed graph, candidate agents are determined from the multiple sub-agents based on the directed graph; and
the interaction agent is determined based on the interaction information, the candidate agents, and a large language model, where the interaction agent is one of the candidate agents.

Among them, if the current node is the start node in the directed graph, the current node may automatically flow to the root node in the directed graph. As an example, a successor node of the root node may be used as the candidate agent, for example, Agent1, Agent2, and Agent3 may be used as the candidate agent.

Further, a prompt text “prompt” may be constructed based on the interaction information and the candidate agent, for example, the interaction information and related information of the candidate agent may be concatenated to the prompt text. Among them, the related information of the candidate agent may include an identification, function description information, etc., of the candidate agent. After that, the prompt text is input to a large language model, so that the large language model determines an interaction agent from the candidate agent. Among them, the large language model is a pre-trained model, which may be obtained through fine-tuning training based on an existing large language model, and details will not be described here again. As an example, in a non-first round of conversation interaction in the same chat, historical conversation content in the current chat may be concatenated to the prompt text, so as to provide more data support for the selection of the interaction agent by the large language model.

Therefore, with the above technical solution, when the current node is the initial node, the interaction agent that responds to the interaction information may be determined based on the association relationship between the sub-agents indicated in the directed graph, thereby implementing the quick and effective selection of the sub-agent, and ensuring the matching degree between the interaction agent and the interaction information.

In some embodiments, the determining an interaction agent from a target agent may further include:
if the current node is a node corresponding to a sub-agent of a previous round of interaction operations, using a sub-agent corresponding to the current node as the interaction agent.

As mentioned above, in some scenarios, each round of conversation does not need to be executed from the start node in the directed graph, and it may also be executed sequentially based on the sub-agent of the previous round of interactions. Then, the determined current node is the node corresponding to the sub-agent of the previous interaction round of operations. As mentioned above, if the sub-agent of the previous round of interaction operations is Agent1, the current node is Agent1 after the interaction information is acquired in the current round of interaction. At this time, Agent1 may be further determined as the interaction agent. On the one hand, the quick selection of the interaction agent may be implemented, and on the other hand, the processing is directly performed based on the sub-agent of the previous round of interaction operations in the current round of interaction, which may also ensure the coherence and smoothness of the response information in the interaction process of the user to some extent, thereby improving the user experience.

In some embodiments, the determining response information of the interaction information based on the inference result may include:
determining a candidate agent corresponding to the interaction agent from the multiple sub-agents based on the directed graph.

As an example, after the inference result is determined based on the interaction agent, it may be further determined whether the inference result may solve the problem of the interaction information. In this step, a next agent may be further selected based on the directed graph.

As an example, the determining a candidate agent corresponding to the interaction agent from the multiple sub-agents based on the directed graph includes:
if the interaction agent is a first type, using an existing candidate agent and an agent corresponding to a successor node of a node of the interaction agent in the directed graph as the candidate agent.

Among them, the candidate agent may be a global variable, so as to record the candidate agent determined during the process execution. The type of each sub-agent may be configured according to an actual application scenario during the registration process of the sub-agent. In this embodiment, the initial node is the start node and automatically flows to the root node. At this time, the existing candidate agent is empty. Based on the directed graph, the successor nodes Agent1, Agent2, and Agent3 of the root node may be used as the candidate agent, and Agent1 is selected from the candidate agent as the interaction agent. Further, the interaction agent Agent1 is the first type, the existing candidate agent and the agent corresponding to the successor node of the node of the interaction agent in the directed graph may be used as the candidate agent. At this time, the existing candidate agent is Agent1, Agent2, and Agent3, and the agents corresponding to the successor nodes of the node of the interaction agent Agent1 are Agent11 and Agent12, and the determined candidate agent includes Agent1, Agent2, Agent3, Agent11, and Agent12. That is, in this scenario, the candidate agent NextStepNodes is determined by:

NextStepNodes=NextStepNodes+the successor node of the current interaction agent node.

If the interaction agent is a second type, an agent corresponding to a successor node of a node of the interaction agent in the directed graph is used as the candidate agent.

As another example, in another chat process, the initial node is the start node and automatically flows to the root node. At this time, the existing candidate agent is empty. Based on the directed graph, the successor nodes Agent1, Agent2, and Agent3 of the root node may be used as the candidate agent, and Agent2 is selected from the candidate agent as the interaction agent. Further, the interaction agent Agent2 is the second type, the agent corresponding to the successor node of the node of the interaction agent in the directed graph may be used as the candidate agent. At this time, the existing candidate agent is Agent1, Agent2, and Agent3, and the agents corresponding to the successor nodes of the node of the interaction agent Agent2 are Agent21 and Agent22, and the determined candidate agent includes Agent21 and Agent12. That is, in this scenario, the candidate agent NextStepNodes is determined by:

Nextstepnodes=the Successor Node of the Current Interaction Agent Node.

Therefore, with the above technical solution, the candidate agent corresponding to the interaction agent may be determined based on the type of the interaction agent, so as to select the next agent from the candidate agent subsequently, which may provide effective data support for the selection of the next agent. At the same time, it may also avoid the waste of resources caused by using all sub-agents as candidate agents, and improve the efficiency of the next agent selection.

After the candidate agent is determined, a next agent may be determined based on the inference result, the interaction information, the candidate agents, and a large language model, where the next agent is one of the candidate agents.

As an example, for the first-type interaction agent, a prompt text “prompt” may be constructed based on the inference result, the interaction information, and the candidate agent. The prompt text is as follows: You may obtain the task and requirement of the user from the chat history, and the last object is the current interaction information user_input. You must select the most appropriate agent.
#The following is a list of candidate agents:
{Agent}
Only agent_id may be replied, and no other content may be replied.
{chat history}

The above chat history needs to be understood. When the intention of the user changes, an agent that may help the user solve the problem is found from the list of candidate agents, and its agent_id is returned.

Among them, the chat history may include the inference result. If the current interaction is the first round of interaction operation in the chat, it includes the interaction information and the inference result. If the current interaction is a non-first round of interaction operation in the chat, it may include the interaction content of the historical round in the current chat, as well as the interaction information and the inference result of the current round. Therefore, the above information may be concatenated to the corresponding position in the prompt text, and then the prompt text is input to the large language model, so that the large language model selects an identification of an agent from multiple agents and returns the identification.

As an example, for the second-type interaction agent, the interaction agent may also be determined by the above manner. As another example, the determining a next agent based on the inference result, the interaction information, the candidate agent, and a large language model may include:
if the interaction agent is a second-type node, constructing a tool for the interaction agent based on the candidate agent, and determining a target tool from a tool set of the interaction agent by the large language model according to the inference result and the interaction information, where the tool set includes a tool constructed by the candidate agent.

In this step, the tool construction may be performed based on the candidate agent based on a general tool construction manner for the agent in the art, which will not be repeated here. Then, the candidate agent may be used as multiple tools carried by the interaction agent. In the above example, Agent21 and Agent22 may be used to construct tool 21 and tool 22, and then the prompt text may be constructed through the inference result, the interaction information, and the tool set and input to the large language model, so that the large language model may select the target tool from the tool set based on the tool selection logic. Among them, the tool selection logic may be implemented based on the existing Agent tool selection logic in the art, thereby implementing the reuse of the existing logic code and reducing the complexity of the implementation code of the method of the present disclosure.

The next agent is determined based on the target tool.

If the target tool is a tool constructed by the candidate agent, the candidate agent corresponding to the target tool may be used as the next agent.

Further, after the next agent is determined, whether it is necessary to continue inference may be determined based on the next agent.

As an example, the interaction agent is the first type. Correspondingly, the determining whether it is necessary to continue inference based on the next agent may include the following.
if the next agent is different from the interaction agent, it is determined that it is necessary to continue inference. That is, the next agent is another agent, which needs to perform a different data inference process. In this case, it is considered that the inference needs to be continued, and the process may flow to the next agent to perform data inference.

If the next agent is the same as the interaction agent, it is determined that it is not necessary to continue inference, that is, the next agent is still the current interaction agent, and its inference process has been completed and does not need to be inferred again, at this time, it may be considered that there is no need to continue inference, that is, the inference process of the target agent ends.

As an example, the interaction agent is the second type. Correspondingly, the determining whether it is necessary to continue inference based on the next agent may include the following.
if the target tool is a tool constructed based on the candidate agent, it is determined that it is necessary to continue inference. That is, the selected target tool is a tool corresponding to the sub-agent in the directed graph. At this time, it is necessary to further perform data inference based on the agent corresponding to the selected target tool, and it is considered that the inference needs to be continued, and the process may flow to the agent corresponding to the target tool to perform data inference.

If the target tool is not a tool constructed based on the candidate agent, it is determined that it is not necessary to continue inference. At this time, it is considered that there is no need to further perform data inference based on the sub-agent in the directed graph, and it may be considered that there is no need to continue inference, that is, the inference process of the target agent ends.

Therefore, with the above technical solution, it may be accurately determined whether the inference needs to be continued based on the sub-agent in the directed graph, thereby determining whether the inference process of the target agent is completed, so as to ensure the accuracy and effectiveness of the finally determined response information.

If it is determined that it is not necessary to continue inference, the inference result determined by the latest interaction agent is used as the response information.

If it is determined that there is no need to continue inference, that is, the inference process of the target agent is completed. At this time, the inference result determined by the latest interaction agent is used as the response information. For example, if the next agent determined by Agent1 is Agent1, it is determined that there is no need to continue inference, and the inference result of Agent1 is used as the response information.

Therefore, with the above technical solution, the response information corresponding to the interaction information may be obtained by determining whether it is necessary to continue inference, thereby ensuring the matching degree between the response information and the interaction information.

In some embodiments, the determining response information of the interaction information based on the inference result may further include:
if it is determined that it is necessary to continue inference, using the next agent as a new interaction agent, determining an inference result of the interaction information based on the inference result, a prompt corresponding to the new interaction agent, and a model corresponding to the new interaction agent, and returning to the step of determining a candidate agent corresponding to the interaction agent from the multiple sub-agents based on the directed graph.

As an example, the current interaction agent is Agent1, and the determined next agent is Agent11. If the two agents are different, it is determined that the inference needs to be continued. At this time, the next agent Agent11 may be used as the new interaction agent. The inference result of the interaction information is determined based on the inference result, the prompt corresponding to the new interaction agent Agent11, and the model corresponding to the new interaction agent Agent11. For example, the prompt text may be constructed based on the inference result of Agent1, the interaction information, and the prompt corresponding to Agent11, and the prompt text is input to the model corresponding to Agent11, to obtain the inference result of the interaction information by Agent11.

Return to the step of determining a candidate agent corresponding to the interaction agent from the multiple sub-agents based on the directed graph, the step of determining a next agent based on the inference result, the interaction information, the candidate agent, and a large language model, and the step of determining whether it is necessary to continue inference based on the next agent, until it is determined that there is no need to continue inference.

That is, after that, Agent11 is used as the interaction agent, and the candidate agent of Agent11 is further determined based on the directed graph, and the next agent is determined, so as to determine whether the inference needs to be continued based on the next agent. The specific implementation of the above steps has been described above and will not be repeated here.

Therefore, with the above technical solution, the sub-agent executed during the execution of the target agent may be dynamically determined based on the directed graph, thereby improving the diversity during the execution of the target agent and the matching degree with the actual application scenario. In addition, since the prompts of different sub-agents are different, that is, the inference tasks they process are different, different sub-agents may focus on one type of task, reducing the complexity of model task processing of the sub-agents, thereby improving the accuracy of the inference result of each interaction agent, further improving the accuracy of the finally determined response information, meeting the needs of the user, and improving the user experience.

Based on the same inventive concept, the present disclosure further provides an agent interaction apparatus. As shown in FIG. 3, the apparatus 10 includes:
an acquisition module 100, configured to acquire interaction information corresponding to an interaction operation;
a first determination module 200, configured to determine an interaction agent from a target agent, where the target agent includes multiple sub-agents with an association relationship, different sub-agents correspond to different prompts, and the interaction agent is one of the multiple sub-agents;
a second determination module 300, configured to determine an inference result of the interaction information based on a prompt corresponding to the interaction agent and a model corresponding to the interaction agent; and
a processing module 400, configured to determine response information of the interaction information based on the inference result, and output the response information.

Optionally, the association relationship between the multiple sub-agents is represented by a directed graph, and each of the sub-agents corresponds to a node in the directed graph;
the first determination module includes:
a first determination sub-module, configured to determine a current node in the directed graph;
a second determination sub-module, configured to determine a candidate agent from the multiple sub-agents based on the directed graph, if the current node is a start node in the directed graph; and
a third determination sub-module, configured to determine the interaction agent based on the interaction information, the candidate agents, and a large language model, where the interaction agent is one of the candidate agents.

Optionally, the first determination module further includes:
a fourth determination sub-module, configured to use a sub-agent corresponding to the current node as the interaction agent, if the current node is a node corresponding to a sub-agent of a previous round of interaction operations.

Optionally, the first determination sub-module includes:
an acquisition sub-module, configured to acquire configuration information of the target agent;
a fifth determination sub-module, configured to use the start node in the directed graph as the current node, if the configuration information indicates that an initial node of the interaction operation is the start node; and
a sixth determination sub-module, configured to use a node corresponding to a sub-agent of a previous round of interaction operations as the current node, if the configuration information does not indicate that the initial node of the interaction operation is the start node.

Optionally, the processing module includes:
a seventh determination sub-module, configured to determine a candidate agent corresponding to the interaction agent from the multiple sub-agents based on the directed graph;
an eighth determination sub-module, configured to determine a next agent based on the inference result, the interaction information, the candidate agents, and a large language model, where the next agent is one of the candidate agents;
a ninth determination sub-module, configured to determine whether it is necessary to continue inference based on the next agent; and
a first processing sub-module, configured to use the inference result determined by the latest interaction agent as the response information, if it is determined that it is not necessary to continue inference.

Optionally, the processing module further includes:
a second processing sub-module, configured to use the next agent as a new interaction agent, if it is determined that it is necessary to continue inference, determine an inference result of the interaction information based on the inference result, a prompt corresponding to the new interaction agent, and a model corresponding to the new interaction agent, and trigger the seventh determination sub-module to determine the candidate agent corresponding to the interaction agent from the multiple sub-agents based on the directed graph.

Optionally, the seventh determination sub-module is further configured to:
use an existing candidate agent and an agent corresponding to a successor node of a node of the interaction agent in the directed graph as the candidate agent, if the interaction agent is the first type; and
use an agent corresponding to a successor node of a node of the interaction agent in the directed graph as the candidate agent, if the interaction agent is the second type.

Optionally, the eighth determination sub-module is further configured to:
if the interaction agent is a second-type node, construct a tool for the interaction agent based on the candidate agent, and determine a target tool from a tool set of the interaction agent by the large language model according to the inference result and the interaction information, where the tool set includes a tool constructed by the candidate agent; and
determine the next agent based on the target tool.

Optionally, the ninth determination sub-module includes:
a tenth determination sub-module, configured to determine that it is necessary to continue inference if the target tool is a tool constructed based on the candidate agent; and determine that it is not necessary to continue inference if the target tool is not a tool constructed based on the candidate agent.

Optionally, the interaction agent is the first type;
the ninth determination sub-module includes:
an eleventh determination sub-module, configured to determine that it is necessary to continue inference if the next agent is different from the interaction agent; and determine that it is not necessary to continue inference if the next agent is the same as the interaction agent.

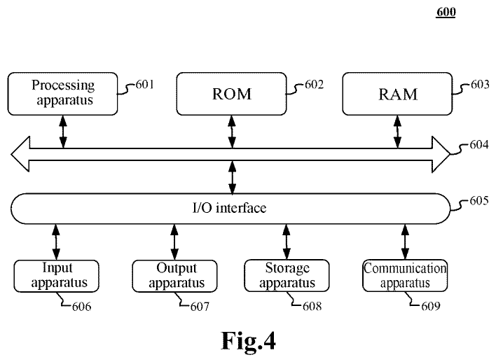

Reference is made to FIG. 4 below, which illustrates a schematic diagram of a structure of an electronic device (e.g., a terminal device or a server) 600 suitable for implementing the embodiments of the present disclosure. The terminal device in the embodiments of the present disclosure may include, but is not limited to, a mobile terminal such as a mobile phone, a laptop, a digital broadcast receiver, a personal digital assistant (PDA), a tablet computer, a portable media player (PMP), a vehicle-mounted terminal (e.g., a vehicle navigation terminal), etc., and a fixed terminal such as a digital TV, a desktop computer, etc. The electronic device shown in FIG. 4 is only an example, and should not impose any limitation on the function and scope of use of the embodiments of the present disclosure.

As shown in FIG. 4, the electronic device 600 may include a processing apparatus (e.g., a central processing unit, a graphics processor, etc.) 601 that may perform various appropriate actions and processing according to a program stored in a read-only memory (ROM) 602 or a program loaded from a storage apparatus 608 into a random access memory (RAM) 603. The RAM 603 further stores various programs and data required for the operation of the electronic device 600. The processing apparatus 601, the ROM 602, and the RAM 603 are connected to each other through a bus 604. An input/output (I/O) interface 605 is also connected to the bus 604.

Usually, the following apparatuses may be connected to the I/O interface 605: an input apparatus 606 including, for example, a touch screen, a touchpad, a keyboard, a mouse, a camera, a microphone, an accelerometer, a gyroscope, etc.; an output apparatus 607 including, for example, a liquid crystal display (LCD), a speaker, a vibrator, etc.; a storage apparatus 608 including, for example, a magnetic tape, a hard disk, etc.; and a communication apparatus 609. The communication apparatus 609 may allow the electronic device 600 to perform wireless or wired communication with other devices to exchange data. Although FIG. 4 shows the electronic device 600 having various apparatuses, it should be understood that not all of the shown apparatuses are required to be implemented or provided. Alternatively, more or fewer apparatuses may be implemented or provided.

In particular, according to the embodiments of the present disclosure, the process described above with reference to the flowchart may be implemented as a computer software program. For example, the embodiments of the present disclosure include a computer program product, which includes a computer program carried by a non-transitory computer-readable medium, where the computer program includes program code for performing the method shown in the flowchart. In such an embodiment, the computer program may be downloaded and installed from a network via the communication apparatus 609, or installed from the storage apparatus 608, or installed from the ROM 602. When the computer program is executed by the processing apparatus 601, the above-mentioned functions defined in the method of the embodiments of the present disclosure are executed.

It should be noted that the above-mentioned computer-readable medium in the present disclosure may be a computer-readable signal medium, a computer-readable storage medium, or any combination of the two. The computer-readable storage medium may be, for example, but is not limited to, an electrical, magnetic, optical, electromagnetic, infrared, or semiconductor system, apparatus, device, or any combination of the above. More specific examples of the computer-readable storage medium may include, but are not limited to: an electrically connected portable computer disk with one or more wires, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, a computer-readable storage medium may be any tangible medium that contains or stores a program, which may be used by or in combination with an instruction execution system, apparatus, or device. In the present disclosure, a computer-readable signal medium may include a data signal propagated on a baseband or as a part of a carrier wave, and computer-readable program code is carried therein. This propagated data signal may adopt multiple forms, including but not limited to, an electromagnetic signal, an optical signal, or any suitable combination of the above. The computer-readable signal medium may also be any computer-readable medium other than the computer-readable storage medium, and the computer-readable signal medium may send, propagate, or transmit a program used by or in combination with an instruction execution system, apparatus, or device. The program code contained on the computer-readable medium may be transmitted by any suitable medium, including but not limited to: a wire, an optical cable, a radio frequency (RF), etc., or any suitable combination of the above.

In some implementations, clients and servers may communicate using any currently known or future developed network protocol, such as the hypertext transfer protocol (HTTP), and may be interconnected with any form or medium of digital data communication (for example, a communication network). Examples of the communication network include a local area network (“LAN”), a wide area network (“WAN”), an internet (for example, the Internet), a peer-to-peer network (for example, an Ad-Hoc network), and any network currently known or to be developed in the future.

The above-mentioned computer-readable medium may be included in the above-mentioned electronic device, or it may exist alone without being assembled into the electronic device.

The above-mentioned computer-readable medium carries one or more programs, and when the one or more programs are executed by the electronic device, the electronic device: acquires interaction information corresponding to an interaction operation; determines an interaction agent from a target agent, where the target agent includes multiple sub-agents with an association relationship, different sub-agents correspond to different prompts, and the interaction agent is one of the multiple sub-agents; determines an inference result of the interaction information based on a prompt corresponding to the interaction agent and a model corresponding to the interaction agent; and determines response information of the interaction information based on the inference result, and outputs the response information.

The computer program code for performing the operations of the present disclosure may be written in one or more programming languages or a combination thereof. The above-mentioned programming languages include but are not limited to object-oriented programming languages such as Java, Smalltalk, and C++, and include conventional procedural programming languages such as “C” language or similar programming languages. The program code may be completely executed on a user computer, partially executed on a user computer, executed as an independent software package, partially executed on a user computer and partially executed on a remote computer, or completely executed on a remote computer or server. In the case of involving a remote computer, the remote computer may be connected to the user computer through any kind of network, including a local area network (LAN) or a wide area network (WAN), or it may be connected to an external computer (for example, connected by using Internet provided by an Internet service provider).

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, program segment, or part of code, which contains one or more executable instructions for implementing the specified logical functions. It should also be noted that, in some alternative implementations, the functions marked in the blocks may also occur in an order different from that marked in the drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The modules involved in the embodiments of the present disclosure may be implemented by software or by hardware. The name of a module does not constitute a limitation on the module itself under certain circumstances. For example, the acquisition module may also be described as “a module for acquiring interaction information corresponding to an interaction operation”.

The functions described above may be at least partially performed by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semi-conductive system, apparatus, or device, or any suitable combination of the above. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

According to one or more embodiments of the present disclosure, Example 1 provides an agent interaction method, including:
acquiring interaction information corresponding to an interaction operation;
determining an interaction agent from a target agent, where the target agent includes multiple sub-agents with an association relationship, different sub-agents correspond to different prompts, and the interaction agent is one of the multiple sub-agents;
determining an inference result of the interaction information based on a prompt corresponding to the interaction agent and a model corresponding to the interaction agent; and
determining response information of the interaction information based on the inference result, and outputting the response information.

According to one or more embodiments of the present disclosure, Example 2 provides the method of Example 1, where the association relationship between the multiple sub-agents is represented by a directed graph, and each of the sub-agents corresponds to a node in the directed graph;
the determining an interaction agent from a target agent includes:
determining a current node in the directed graph;
determining a candidate agent from the multiple sub-agents based on the directed graph, if the current node is a start node in the directed graph; and
determining the interaction agent based on the interaction information, the candidate agents, and a large language model, where the interaction agent is one of the candidate agents.

According to one or more embodiments of the present disclosure, Example 3 provides the method of Example 2, where the determining an interaction agent from a target agent further includes:
using a sub-agent corresponding to the current node as the interaction agent, if the current node is a node corresponding to a sub-agent of a previous round of interaction operations.

According to one or more embodiments of the present disclosure, Example 4 provides the method of Example 2, where the determining a current node in the directed graph includes:
acquiring configuration information of the target agent;
using the start node in the directed graph as the current node, if the configuration information indicates that an initial node of the interaction operation is the start node; and
using a node corresponding to a sub-agent of a previous round of interaction operations as the current node, if the configuration information does not indicate that the initial node of the interaction operation is the start node.

According to one or more embodiments of the present disclosure, Example 5 provides the method of Example 1, where the determining response information of the interaction information based on the inference result includes:
determining a candidate agent corresponding to the interaction agent from the multiple sub-agents based on the directed graph;
determining a next agent based on the inference result, the interaction information, the candidate agents, and a large language model, where the next agent is one of the candidate agents;
determining whether it is necessary to continue inference based on the next agent; and
using the inference result determined by the latest interaction agent as the response information, if it is determined that it is not necessary to continue inference.

According to one or more embodiments of the present disclosure, Example 6 provides the method of Example 5, where the determining response information of the interaction information based on the inference result further includes:
if it is determined that it is necessary to continue inference, using the next agent as a new interaction agent, determining an inference result of the interaction information based on the inference result, a prompt corresponding to the new interaction agent and a model corresponding to the new interaction agent, and returning to the step of determining the candidate agent corresponding to the interaction agent from the multiple sub-agents based on the directed graph.

According to one or more embodiments of the present disclosure, Example 7 provides the method of Example 5, where the determining a candidate agent corresponding to the interaction agent from the multiple sub-agents based on the directed graph includes:
using an existing candidate agent and an agent corresponding to a successor node of a node of the interaction agent in the directed graph as the candidate agent, if the interaction agent is the first type; and
using an agent corresponding to a successor node of a node of the interaction agent in the directed graph as the candidate agent, if the interaction agent is the second type.

According to one or more embodiments of the present disclosure, Example 8 provides the method of Example 7, where the determining a next agent based on the inference result, the interaction information, the candidate agent, and a large language model includes:
if the interaction agent is a second-type node, constructing a tool for the interaction agent based on the candidate agent, and determining a target tool from a tool set of the interaction agent by the large language model according to the inference result and the interaction information, where the tool set includes a tool constructed by the candidate agent; and
determining the next agent based on the target tool.

According to one or more embodiments of the present disclosure, Example 9 provides the method of Example 8, where the determining whether it is necessary to continue inference based on the next agent includes:
determining that it is necessary to continue inference if the target tool is a tool constructed based on the candidate agent; and
determining that it is not necessary to continue inference if the target tool is not a tool constructed based on the candidate agent.

According to one or more embodiments of the present disclosure, Example 10 provides the method of Example 7, where the interaction agent is the first type;
the determining whether it is necessary to continue inference based on the next agent includes:
determining that it is necessary to continue inference if the next agent is different from the interaction agent; and
determining that it is not necessary to continue inference if the next agent is the same as the interaction agent.

According to one or more embodiments of the present disclosure, Example 11 provides an agent interaction apparatus, including:
an acquisition module, configured to acquire interaction information corresponding to an interaction operation;
a first determination module, configured to determine an interaction agent from a target agent, where the target agent includes multiple sub-agents with an association relationship, different sub-agents correspond to different prompts, and the interaction agent is one of the multiple sub-agents;
a second determination module, configured to determine an inference result of the interaction information based on a prompt corresponding to the interaction agent and a model corresponding to the interaction agent; and
a processing module, configured to determine response information of the interaction information based on the inference result, and output the response information.

According to one or more embodiments of the present disclosure, Example 12 provides a computer-readable medium having a computer program stored thereon, where the computer program, when executed by a processing apparatus, implements the steps of the method according to any one of Examples 1-10.

According to one or more embodiments of the present disclosure, Example 13 provides an electronic device, including:
a storage apparatus, having a computer program stored thereon; and
a processing apparatus, configured to execute the computer program in the storage apparatus to implement the steps of the method according to any one of Examples 1-10.

According to one or more embodiments of the present disclosure, Example 14 provides a computer program product including a computer program, where the computer program, when executed by a processor, implements the steps of the method according to any one of Examples 1-10.

The above description is only preferred embodiments of the present disclosure and an explanation of the technical principles employed. Those skilled in the art should understand that the scope of disclosure involved in the present disclosure is not limited to the technical solutions formed by the specific combination of the above-mentioned technical features, and should also cover, without departing from the above-mentioned disclosed concept, other technical solutions formed by any combination of the above-mentioned technical features or their equivalent features. For example, a technical solution formed by replacing the above features with technical features with similar functions disclosed in the present disclosure (but not limited thereto) also falls within the scope of the present disclosure.

Additionally, although operations are depicted in a particular order, it should not be understood that these operations are required to be performed in a specific order as illustrated or in a sequential order. Under certain circumstances, multitasking and parallel processing may be advantageous. Likewise, although the above discussion includes several specific implementation details, these should not be interpreted as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combinations.

Although the subject matter has been described in language specific to structural features and/or logical actions of the method, it should be understood that the subject matter defined in the appended claims is not necessarily limited to the specific features or actions described above. Rather, the specific features and actions described above are merely example forms for implementing the claims. Regarding the apparatuses in the above embodiments, the specific manner in which each module performs an operation has been described in detail in the embodiments relating to the method, and will not be detailed herein.

I/We claim:

1. An agent interaction method, comprising:
acquiring interaction information corresponding to an interaction operation;
determining an interaction agent from a target agent, wherein the target agent comprises a plurality of sub-agents with an association relationship, different sub-agents correspond to different prompts, and the interaction agent is one sub-agent of the plurality of sub-agents;
determining an inference result of the interaction information based on a prompt corresponding to the interaction agent and a model corresponding to the interaction agent; and
determining response information of the interaction information based on the inference result, and outputting the response information.

2. The method of claim 1, wherein the association relationship between the plurality of sub-agents is represented by a directed graph, and each sub-agent of the sub-agents corresponds to a node in the directed graph; and
determining the interaction agent from the target agent comprises:
determining a current node in the directed graph;
determining candidate agents from the plurality of sub-agents based on the directed graph, in response to the current node being a start node in the directed graph; and
determining the interaction agent based on the interaction information, the candidate agents, and a large language model, wherein the interaction agent is one of the candidate agents.

3. The method of claim 2, wherein determining the interaction agent from the target agent further comprises:
using a sub-agent corresponding to the current node as the interaction agent, in response to the current node being a node corresponding to a sub-agent of a previous round of interaction operations.

4. The method of claim 2, wherein determining the current node in the directed graph comprises:
acquiring configuration information of the target agent;
using the start node in the directed graph as the current node, in response to the configuration information indicating that an initial node of the interaction operation is the start node; and
using a node corresponding to a sub-agent of a previous round of interaction operations as the current node, in response to the configuration information not indicating that the initial node of the interaction operation is the start node.

5. The method of claim 1, wherein determining the response information of the interaction information based on the inference result comprises:
determining candidate agents corresponding to the interaction agent from the plurality of sub-agents based on the directed graph;
determining a next agent based on the inference result, the interaction information, the candidate agents, and a large language model, wherein the next agent is one candidate agent of the candidate agents;
determining whether it is necessary to continue inference based on the next agent; and
using the inference result determined by the latest interaction agent as the response information, in response to determining that it is not necessary to continue the inference.

6. The method of claim 5, wherein determining the response information of the interaction information based on the inference result further comprises:
using the next agent as a new interaction agent, determining an inference result of the interaction information based on the inference result, a prompt corresponding to the new interaction agent and a model corresponding to the new interaction agent, and returning to a step of determining the candidate agents corresponding to the interaction agent from the plurality of sub-agents based on the directed graph, in response to determining that it is necessary to continue the inference.

7. The method of claim 5, wherein determining the candidate agents corresponding to the interaction agent from the plurality of sub-agents based on the directed graph comprises:
using an existing candidate agent and an agent corresponding to a successor node of a node of the interaction agent in the directed graph as the candidate agents, in response to the interaction agent being a first type; and
using the agent corresponding to the successor node of the node of the interaction agent in the directed graph as the candidate agents, in response to the interaction agent being a second type.

8. The method of claim 7, wherein determining the next agent based on the inference result, the interaction information, the candidate agents, and the large language model comprises:
constructing a tool for the interaction agent based on the candidate agents, and determining a target tool from a tool set of the interaction agent by the large language model based on the inference result and the interaction information, in response to the interaction agent being a second-type node, wherein the tool set comprises a tool constructed by the candidate agents; and
determining the next agent based on the target tool.

9. The method of claim 8, wherein determining whether it is necessary to continue the inference based on the next agent comprises:
determining that it is necessary to continue the inference, in response to the target tool being a tool constructed based on the candidate agents; and
determining that it is not necessary to continue the inference, in response to the target tool not being a tool constructed based on the candidate agents.

10. The method of claim 7, wherein the interaction agent is of a first type; and
determining whether it is necessary to continue the inference based on the next agent comprises:
determining that it is necessary to continue the inference, in response to the next agent being different from the interaction agent; and
determining that it is not necessary to continue the inference, in response to the next agent being the same as the interaction agent.

11. A non-transitory computer-readable medium, having a computer program stored thereon, wherein the computer program, when executed by a processor, causing the processor to:
acquire interaction information corresponding to an interaction operation;
determine an interaction agent from a target agent, wherein the target agent comprises a plurality of sub-agents with an association relationship, different sub-agents correspond to different prompts, and the interaction agent is one sub-agent of the plurality of sub-agents;
determine an inference result of the interaction information based on a prompt corresponding to the interaction agent and a model corresponding to the interaction agent; and
determine response information of the interaction information based on the inference result, and output the response information.

12. An electronic device, comprising:
a memory, having a computer program stored thereon; and
a processor, configured to execute the computer program in the memory to:
acquire interaction information corresponding to an interaction operation;
determine an interaction agent from a target agent, wherein the target agent comprises a plurality of sub-agents with an association relationship, different sub-agents correspond to different prompts, and the interaction agent is one sub-agent of the plurality of sub-agents;
determine an inference result of the interaction information based on a prompt corresponding to the interaction agent and a model corresponding to the interaction agent; and
determine response information of the interaction information based on the inference result, and output the response information.

13. The electronic device of claim 12, wherein the association relationship between the plurality of sub-agents is represented by a directed graph, and each sub-agent of the sub-agents corresponds to a node in the directed graph; and
wherein the computer program causing the processor to determine the interaction agent from the target agent comprises instructions to:
determine a current node in the directed graph;
determine candidate agents from the plurality of sub-agents based on the directed graph, in response to the current node being a start node in the directed graph; and
determine the interaction agent based on the interaction information, the candidate agents, and a large language model, wherein the interaction agent is one of the candidate agents.

14. The electronic device of claim 13, wherein the computer program causing the processor to determine the interaction agent from the target agent further comprises instructions to:
use a sub-agent corresponding to the current node as the interaction agent, in response to the current node being a node corresponding to a sub-agent of a previous round of interaction operations.

15. The electronic device of claim 13, wherein the computer program causing the processor to determine the current node in the directed graph comprises instructions to:
acquire configuration information of the target agent;
use the start node in the directed graph as the current node, in response to the configuration information indicating that an initial node of the interaction operation is the start node; and
use a node corresponding to a sub-agent of a previous round of interaction operations as the current node, in response to the configuration information not indicating that the initial node of the interaction operation is the start node.

16. The electronic device of claim 12, wherein the computer program causing the processor to determine the response information of the interaction information based on the inference result comprises instructions to:
determine candidate agents corresponding to the interaction agent from the plurality of sub-agents based on the directed graph;
determine a next agent based on the inference result, the interaction information, the candidate agents, and a large language model, wherein the next agent is one candidate agent of the candidate agents;
determine whether it is necessary to continue inference based on the next agent; and
use the inference result determined by the latest interaction agent as the response information, in response to determining that it is not necessary to continue the inference.

17. The electronic device of claim 16, wherein the computer program causing the processor to determine the response information of the interaction information based on the inference result further comprises instructions to:
use the next agent as a new interaction agent, determine an inference result of the interaction information based on the inference result, a prompt corresponding to the new interaction agent and a model corresponding to the new interaction agent, and returning to a step of determining the candidate agents corresponding to the interaction agent from the plurality of sub-agents based on the directed graph, in response to determining that it is necessary to continue the inference.

18. The electronic device of claim 16, wherein the computer program causing the processor to determine the candidate agents corresponding to the interaction agent from the plurality of sub-agents based on the directed graph comprises instructions to:
use an existing candidate agent and an agent corresponding to a successor node of a node of the interaction agent in the directed graph as the candidate agents, in response to the interaction agent being a first type; and
use the agent corresponding to the successor node of the node of the interaction agent in the directed graph as the candidate agents, in response to the interaction agent being a second type.

19. The electronic device of claim 18, wherein the computer program causing the processor to determine the next agent based on the inference result, the interaction information, the candidate agents, and the large language model comprises instructions to:
construct a tool for the interaction agent based on the candidate agents, and determine a target tool from a tool set of the interaction agent by the large language model based on the inference result and the interaction information, in response to the interaction agent being a second-type node, wherein the tool set comprises a tool constructed by the candidate agents; and
determine the next agent based on the target tool.

20. The electronic device of claim 19, wherein the computer program causing the processor to determine whether it is necessary to continue the inference based on the next agent comprises instructions to:
determine that it is necessary to continue the inference, in response to the target tool being a tool constructed based on the candidate agents; and
determine that it is not necessary to continue the inference, in response to the target tool not being a tool constructed based on the candidate agents.
